(19) United States
(12) Patent Application Publication
(10) Pub. No.: US 2009/0327495 A1
(43) Pub. Date: Dec. 31, 2009

(54) COMPUTING WITH LOCAL AND REMOTE RESOURCES USING AUTOMATED OPTIMIZATION

(75) Inventors: Jonathan Betts-LaCroix, San Francisco, CA (US); Richard Pocklington, San Francisco, CA (US)

Correspondence Address: Trellis Intellectual Property Law Group, PC, 1900 EMBARCADERO ROAD, SUITE 109, PALO ALTO, CA, 94303, US

(73) Assignee: OQO, Inc., San Francisco, CA (US)

(21) Appl. No.: 12/163,942

(22) Filed: Jun. 27, 2008

(51) Int. Cl. G06F 15/173

(52) U.S. Cl. 709/226

(57) ABSTRACT

A method for automatically selecting resources to be used by a given computing process. The method includes determining resources that will be required for execution of the process and then ascertaining availability at and capabilities of local and remote resources at a desired processing time. An appropriate combination of resources is then selected from local and remote resources that will satisfy one or more predetermined criteria. A second method represents a method for allocating local and/or remote computing resources. Local computing resources include local processing power and local storage. Remote computing resources include remote processing power and remote storage. The method includes receiving an indication of a function to be performed at a future time; then determining a local resource limitation of performing the function at the future time; and then automatically allocating one or more of the remote computing resources for performance of the function.

### REFERENCE TO RELATED APPLICATIONS

This application is related to the following co-pending patent applications which are each hereby incorporated by reference as if set forth in full in this specification for all purposes:

1. U.S. patent application Ser. No. ______ [TBD] entitled “SELECTION OF VIRTUAL COMPUTING RESOURCES USING HARDWARE MODEL REPRESENTATIONS,” filed on Jun. 27, 2008 (Attorney docket numbers 100127-002900US and OQO/COM0438S); and

2. U.S. patent application Ser. No. ______ [TBD] entitled “COMPUTING WITH LOCAL AND REMOTE RESOURCES INCLUDING USER MODE CONTROL,” filed on Jun. 27, 2008 (Attorney docket numbers 100127-002800US and OQO/COM0607S).

### BACKGROUND

One typical approach to computing provides a user with a local computer system. The local computer system can include local computing resources such as processing power, storage capacity, bandwidth for data transfers, output capability (e.g., display, audio speakers, etc.), input capability (e.g., keyboard, mouse, touch screen, camera, gesture recognition, etc.), and other resources. The user is able to exercise a high degree of control over the local computer system and the local resources in order to perform desired functions to achieve desired results. For example, a user can user computing resources to search and display information, run simulations; create documents, images, video, or other content; send messages, play games, or to perform many other tasks.

In some cases a user may wish to use “virtual” computing resources that are not part of a local, or otherwise dedicated computing system. Typically virtual computing resources can include any of the resources that are available in a dedicated machine, such as a local computer. The virtual computing resources are typically maintained by a different entity that is not under the user's ownership or control. For example, a company may operate dozens or hundreds of remote computers that include the ability to provide many times the amount of processing power, storage capacity, bandwidth or other resources that a user may desire. So a user may benefit from using virtual computing resources to have greater or different processing power at their disposal than they might otherwise obtain. Other advantages of virtual computing resources include allowing a user to “lease” or “buy” virtual computing resources on an as-needed basis. The as-needed basis can vary by time, according to a particular function or task to be performed, or according to other conditions.

Unfortunately, conventional systems and methods for enabling a user of a local machine to use resources of a remote machine often lack important mechanisms for selectively determining how the remote resources should be used.

### SUMMARY

One example embodiment implements a method for automatically selecting resources to be used by a given computing process. The method includes determining resources that will be required for execution of the process and then ascertaining availability and capabilities of local and remote resources at a desired processing time. An appropriate combination of resources is then selected from local and remote resources that will satisfy one or more predetermined criteria.

A second method represents a method for allocating computing resources, including local computing resources and remote computing resources. Local computing resources include local processing power and local storage. Remote computing resources include remote processing power and remote storage. The method includes receiving an indication of a function to be performed at a future time; then determining a local resource limitation of performing the function at the future time; and then automatically allocating one or more of the remote computing resources for performance of the function.

A more specific embodiment of the second method includes determining that performing the function with local computing resources will result in a first time delay to achieve a desired result; then determining that achieving at least a portion of the result by using a selected portion of the remote computing resources will result in a second time delay; then determining that a total time delay of transferring data to the remote computing resources and using the selected portion of the remote computing resources to achieve at least a portion of the result will be less than the first time delay and providing a signal in response thereto; and selectively causing at least a portion of the function to be performed using the selected portion of the remote computing resources in response to the signal.

### BRIEF DESCRIPTION OF THE DRAWINGS

FIG. 1 shows a computing system adapted to facilitate user selection or automatic selection of how local and/or remote computing resources are used to accomplish a computing process or task.

FIG. 2 shows a first example display illustrating a first Graphical User Interface (GUI) with different regions for selecting between local, remote, and automatic selection of reprocessing of files or applications represented by one or more icons.

FIG. 3 shows a second example computing system for enabling automatic allocation of local and/or remote resources to a given process.

FIG. 4 shows a second example GUI, which provides user options to manually select between local or remote resources or to have local or remote resources automatically selected for the performance of a given computing task.

FIG. 5 is a flow diagram of a method adapted for use with the computing systems of FIG. 1 and 3 and the GUI of FIG. 2.

### DETAILED DESCRIPTION OF EMBODIMENTS OF THE INVENTION

For clarity, various well-known components, such as power sources, Internet Service Providers (ISPs), transceivers, firewalls, and so on, have been omitted from the figures. However, those skilled in the art with access to the present teachings will know which components to implement and how to implement them to meet the needs of a given application.

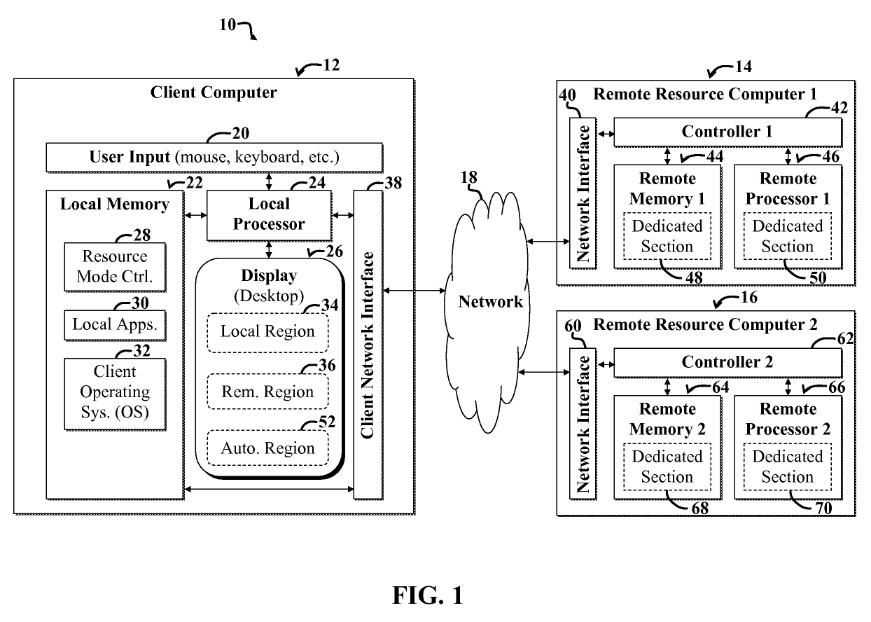

FIG. 1 shows a computing system 10 adapted to enable a user to selectively control how local and/or remote computing resources are used to accomplish one or more functions or tasks.

The computing system 10 includes a client computer 12, which represents a particular user's computer. The client computer 12 is also called the local computer herein. For the purposes of the present discussion, a local computer, or local resources, may be any computer or resources dedicated to a particular user, such that the user has ownership or essentially complete control over the computer's resources. For example, the client computer 12 might represent a user's laptop computer. Since the user has control over the computer 12, the computer is considered dedicated or local. Note that a computer that is geographically remotely positioned from a user may also be considered a “local” computer with “local resources” within the meaning of the terms used herein if the resources are dedicated to the user. Example resources include memory, processing capability, network bandwidth, and so on, as discussed more fully below.

In the present specific embodiment, the client computer 12 is coupled to a first remote resource computer 14 and a second remote resource computer 16 via a network 18. The network 18 may be implemented via virtually any type of suitable computer network, such as the Internet, a Local Area Network (LAN), a wireless LAN, and so on. The exact type of network used is application specific. Although computing resources are presented as contained within a specific computer system, other embodiments can have arbitrary arrangements and organizations of resources. For example, storage devices such as hard drives, banks of RAM, optical drives, etc., can be discrete or separate devices that are individually connected to the network. Similarly, processors can be coupled to a network without being included in a larger system such as a computer system. Many such variations are possible.

The client computer 12 includes user-input devices 20, such as a mouse, keyboard, and so on. The client computer 12 further includes a local memory 22 in communication with a local processor 24. The local processor 24 communicates with the user-input devices 20, a display 26, and a client network interface 38. The client network interface 38 may include a router, firewall, or other devices used to couple the client computer 12 to the network 18. The local memory 22 includes a resource mode-control module 28, other local applications 30, and a client operating system 32. Note that the local memory 22 may store other data or applications, or certain applications may be omitted without departing from the scope of the present teachings. For example, the resource mode-control module 28 may reside on another system, such as first the remote resource computer 14. The mode-control module 28 facilitates implementing various computing modes for processes launched via the client computer 12, including a remote mode, where processing and storage of data for the processing occurs remotely; a local mode where processing and data storage occur locally; a hybrid mode where processing and data storage selectively occur locally or remotely, as discussed more fully below.

Note that the client computer 12 may be implemented via a thin client or another more full-featured computer, such as a laptop computer, pocket PC, cellular telephone, and so on. For the purposes of the present discussion, a thin client may be any computer which is adapted to connect to a remote resource, wherein the remote resource provides a majority of the computing power and applications for running applications thereon. Note that certain thin clients may lack the operating system 32 and may instead include a module for connecting to a remote resource, such as the remote resource computer 14, which may then run an operating system suitable for use by the thin client.

For illustrative purposes, the display 26 of the client computer 12 is shown including a Graphical User Interface, wherein the display 26 is separated into regions, including a local region 34, a remote region 36, and an automatic resource-selection region 52. The regions 34, 36 may be used to define applications that will use local or remote resources, respectively, as discussed more fully below. Icons, which are associated with certain files, applications, or processes and which are positioned in the automatic resource-selection region 52 are automatically allocated local and/or remote resources, as discussed more fully below.

The first remote resource computer 14 of the computing system 10 may communicate with the client computer 12 via the network 18. The first remote resource computer 14 includes a first remote-resource network interface 40, which is coupled to the network 18 and a first controller 42 of the remote resource computer 14. The first controller 42 is coupled to a first remote memory 44, which includes a first dedicated section 48. The controller 42 is further coupled to a first remote processor 46, which includes a second dedicated section 50. The second remote resource computer 16 is constructed similarly to the first remote resource computer 14. The second remote resource computer 16 includes a second remote-resource network interface 60, a second controller 62, a second remote memory 64 with a dedicated section 68, and a second remote processor 66 with a corresponding dedicated section 70.

For the purposes of the present discussion, a remote resource may be any computing feature or capability, such as memory, processing capability, bandwidth, and so on, that is positioned in a different device than the client computer 12. Remote resources are accessed by a client computer, such as the client computer 12, via a network, such as the network 18. A network may be any collection of connected or coupled devices or entities. Remote resources, as discussed herein typically reside on a computer or collection of computers owned and managed by a separate entity than the entity that owns or manages the client computer 12. However, in certain applications or embodiments, a single entity may own both the client computer 12 and resources of the remote resource computers 14, 16.

In the present embodiment, local resources refer to any resources residing on the client computer 12. Note however, that in certain embodiments discussed herein, local resources may be replaced with remote dedicated resources without departing from the scope of the present teachings. For example, systems and methods discussed herein for selectively allocating local or remote resources for a particular function or process may instead be implemented as systems and methods for selectively allocating resources between different remote resources or between predetermined resources that are dedicated to or owned by a user of the client computer 12 and remote resources that are owned by an entity that is separate from the user of the client computer 12.

In operation, various software applications, such as Microsoft Word®, Adobe PhotoShop®, and so on, that are usable by a user of the client computer 12 may be represented by icons or other mechanisms via the display 26. In a particular example embodiment, certain icons may be positioned in the local region 34, the remote region 36, or the automatic resource-selection region 52 (also called the automatic region). The location of an icon in the display 26 affects whether the resource mode controller 28 allocates local resources of the client computer 12 and/or remote resources of the first remote resource computer 14 or the second remote resource computer 16 to implement a given process, task, or function. Icons positioned in the automatic region 52 have resources automatically assigned to associated processes via instructions of the resource mode controller 28. The automatic assignment of resources may be based on a predetermined scheme, such as a predetermined set of criteria, which may be established via one or more computing profiles. Automatic assignment of resources may also be determined based on which selection of remote and local resources will result in a minimum time to complete a given process. The minimum time to complete a given process represents an example criterion.

The resource mode controller 28 includes instructions adapted to determine when a process represented in the local region 34 is activated by a user. The user may employ a user-input device 20 to active the process, such as by double clicking on the associated icon in the local region 34. The causes a signal to be sent to the resource mode control module 28, which may be running via the local processor 24.

Note that while the resource mode controller 28 is shown residing in local memory 22, it may be run by the processor 24. Furthermore, note that remote mode controller 28 may be running on a remote resource, such as the first remote resource computer 14, rather than on the client computer 12.

The signal that is sent to the mode controller 28 includes information about the process that was activated by the user of the client computer 12. This information may further indicate which region 34, 36, 52 the process was activated from. For example, if the process was activated from the local region 34, then the resource mode controller 28 automatically uses the local memory 22 and the local processor 24 to run the process, which may be a local application 30 or process thereof. If the process was activated from the automatic region 52, then local and/or remote resources are automatically allocated to the process based on one or more predetermined criteria. Similarly, if the process was activated from the remote region 36, a corresponding signal is sent to the resource mode controller 28. Instructions included in the resource mode controller 28 then cause the process to use one or more remote resources, such as the first remote memory 48 and the first remote processor 46.

The resource mode controller 28 may include instructions for reserving, for the process, a predetermined amount of bandwidth available via the client network interface 38, network 18, and first remote resource network interface 40 and/or the second remote network interface 60. The resource mode controller 28 may also cause a predetermined portion of remote memory 44 (e.g., first dedicated memory section 48) to be dedicated to the process launched by the client computer 12. Furthermore, the resource mode controller 28 may cause a predetermined portion of remote processing resources 46 (e.g., dedicated section 50) to be dedicated to the process launched by the client computer 12.

Before the resource mode controller 28 causes the process to be implemented via remote resources, such as the first remote memory 44 and remote processor 46, a price breakdown for using the remote resources may be provided to the user of the client computer 12 via the display 26. The user may then accept or decline to use the remote resources. If the user declines to use the remote resources, the launched process or application may be run using local resources of the client computer 12.

Hence, the resource mode-control software 28 of the client computer 12 may include instructions for providing remote resource prices to a user of the client computer 12 for use of a given amount or quality of remote resources used or to be used to perform a given process or task for a given amount of time. Note that the displaying of price information for use of remote resources may be omitted without departing from the scope of the present teachings.

Hence, a user may affect whether a given process, function, or task is implemented using local resources, such as the local memory 22 and local processor 24, or remote resources, such as the remote memories 44, 64 or remote processors 46, 66. A user may further control whether some local resources and some remote resources are used to implement a given process, as discussed more fully below. Alternatively, resource allocation may be automatic. Note that user options to use local resources or remote resources may be omitted without departing from the scope of the present teachings.

The reserve bandwidth for a given process, the resource mode controller 28 may communicate with the network interfaces 38, 40, 60, which may include or may communicate with modules capable of receiving resource reservation instructions from the resource mode controller 28. For example, the first remote resource controller 42 may include instructions responsive to resource a resource reservation signal from the resource mode controller 28. In response to a signal from the resource mode controller 28, the first controller 42 may reserve dedicated sections or portions of resources 48, 50 for use by an associated process. Alternatively, the resource mode controller 28 selectively affects bandwidth usage by strategically scheduling processes that use bandwidth resources.

Note that the local applications 30 running on the client computer 12 may instead reside entirely in memory on a remote computer, such as the first remote resource computer 14 and or the second remote resource computer 16 without departing from the scope of the present teachings. Furthermore, note that the client computer 12 may use resources from a plurality of remote resource computers 14, 16.

While two remote resource computers 14, 16 are shown for illustrative purposes, additional or fewer remote resource computers may be employed without departing from the scope of the present teachings. The remote resource computers 14, 16 may be implemented as servers. For the purposes of the present discussion, a server may be computer or collection of computing resources adapted to provide one or more functions or resources to another computer, such as a client. A client may be any computer or collection of computing resources adapted to use one or more resources of a server.

Furthermore, while a single client computer 12 is shown in FIG. 1, additional client computers may be employed without departing from the scope of the present teachings. Different client computers may reserve different dedicated sections of remote resources via their own resource mode controllers. Furthermore, a given client computer may act as both a client and a server without departing from the scope of the present teachings.

Hence, the client computer 12 may be allocated or assigned dedicated sections or portions 44, 46 of remote resources, which may be reserved or dedicated to the user of the client computer 12 for the performance of a given computing task or process. Furthermore, remote resources may be reserved for a predetermined amount of time and then released. The time for which a remote resource is reserved for use by one or more processes activated via the client computer 12 may depend on the time required to implement a given process or may be set based on some other criteria, such as whether a user has paid a fee for long term reservation of a resource.

Note that the local memory 22 and the remote memories 44, 64 may include different kinds of memory, such as hard drive space, Random Access Memory (RAM), and so on, which may be reserved for a process activated via the client computer 12 or which may be reserved for plural processes activated via the client computer 12 or for a predetermined amount of time. Similarly, the local processor 24 and the remote processors 46, 66 may include banks or processors and may include different types of processes that may be reserved via the client computer 12 and resource mode controller 28. For example, a predetermined number of processors of the first remote processing resources 46 may be reserved by or dedicated for use by the client computer 12 to complete a given computing task or for a predetermined amount of time. The time for which remote resources are used may be scheduled via the resource mode controller 28 and controllers 42, 62 of the remote resource computers 14, 16.

Hence, the computing system 10 may implement a method that includes predetermining two or more resource allocation options, such as the option to use local resources or remote resources for a given computing task. A plurality of predetermined allocation options may be displayed via the display 26. Each option may indicate a different allocation of resources (such as remote or local resource allocation) between at least one resource (local resource) on a local computing system and at least one resource (remote resource) on a remote computing system, such as one of the remote resource computers 14, 16. The resources may be selected from processing power, storage or memory, and or network bandwidth. Note that more or fewer resource selection options may be provided without departing from the scope of the present teachings.

The method further includes determining, such as via user input to the client computer 12, a function to be performed. The function to be performed may be the running of an application or a process associated with a given software application. A user may employ one or more of the user-input devices 20 to select one of a plurality of resource-allocation options in association with the function to be performed. For example, a user may drag an icon representative of a given process or function into the local region 34 or remote region 36 of the display. Upon activating of the associated icon, such as by double clicking the icon, the resource mode controller 28 allocates resources in accordance with the selected resource-allocation option. The selected resource-allocation, as indicated by the selection of the resource-allocation option, is then used to accomplish or implement the function.

Note that while in the present specific embodiment, resource-allocation options are determined by dragging an icon between a local region 34, a remote region 36, and an automatic region 52, other methods for selecting resource-allocation options may be employed. For example, certain resource-allocation menus, with various resource-allocation options selectable thereby, may be provided via the resource mode controller 28 in response to certain hot keys, mouse clicks (e.g., right clicking an icon), and so on, as discussed more fully below.

A resource allocation method implemented via the system 10 may further include displaying first, second, and third areas on a display screen (e.g., the local region 34 and the remote region 36), wherein the first area corresponds to a first allocation of the resources, wherein the second area corresponds to a second allocation of the resources, and wherein the third area corresponds to automatic allocation of a predetermined combination or local and/or remote resources. The method further includes accepting a signal from a user-input device to move an icon from the first area into the second area and then changing an allocation of the resources from the first allocation to the second allocation, such as an automatic allocation. The second allocation or resources is then used to perform a task associated with the icon.

The computing system 10 may also implement a method that includes receiving, at the resource mode controller 28, an indication of a function or process to be performed at a future time, such as in response to a user double clicking an icon associated with the function or process. A local resource limitation of performing the process or function at the future time is then determined. Subsequently, one or more of the remote computing resources are automatically allocated for the performance of the function based on the local resource limitation.

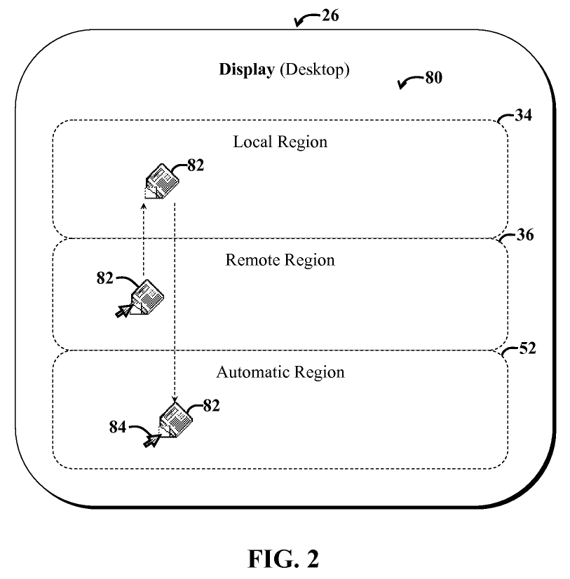

FIG. 2 shows an example display illustrating a first Graphical User Interface (GUI) 80 with different regions 34, 36, 52 for local, remote, and automatic use of resources to process files or applications represented by one or more icons 82. Allocation of resources to a given process or file is determined by where an icon pertaining to the process or file is positioned in the display 26.

In operation, when the process associated with icon 82 is activated while in the remote region 36, one or more remote computing resources are used to implement the process. Similarly, when a user employs a mouse 84 to drag the icon 82 to the local region 34, allocation options associated with the process referred to by the icon 82 are changed from remote resources to local resources. When the process is activated via the icon 82 when the icon is in the local region 34, one or more local resources are used to implement the process.

When the icon 82 is activated while in the automatic region 52, certain local and/or remote resources may automatically be selected based on one or more predetermined criteria. This predetermined criteria may be set by establishing one or more profiles or by otherwise setting other options or criteria. Alternatively, such criteria may be set automatically based on default criteria. An example default criterion may be that the given process associated with the icon 82 is implemented in the least amount of time. The choice of local and remote resources may depend on the nature of the process and the capabilities of the local, remote, and bandwidth resources. For example, a process that calculates pie to 1 trillion digits may best be run on one or more remote processors, if the remote processors have substantially more processing capabilities than the local processor 24. For this example process, bandwidth needed to transfer the process to the remote processors 46, 66 may be minimal, such that any delay caused by bandwidth limitations outweighs time savings achieved by using remote processing resources. Instructions for implementing such automatic selection may reside in the resource mode-control module 28 or may be locally positioned. Note that the resource mode-control module 28 may be distributed among different modules and among different computers without departing from the scope of the present teachings.

Hence, a method for automatically selecting resources to be used by a given process may include determining resources that will be required by the process; determining resource availability at and capabilities at a desired processing time; and selecting an appropriate combination of local and/or remote resources that will approximately minimize the time required to execute the process.

Another method may include determining a local resource limitation, such as that use of a local resource will cause execution of a process to take a predetermined amount of time, such as longer than use of a corresponding remote resource; then determining a remote resource limitation for performing the function, such as that use of a remote resource will cause execution of a given process to take a predetermined amount of time; and then automatically determining whether to allocate, for execution of the process, one or more local resources, one or more remote resources, or a combination of one or more local resources or one or more remote resources based on the local resource limitation and the remote resource limitation.

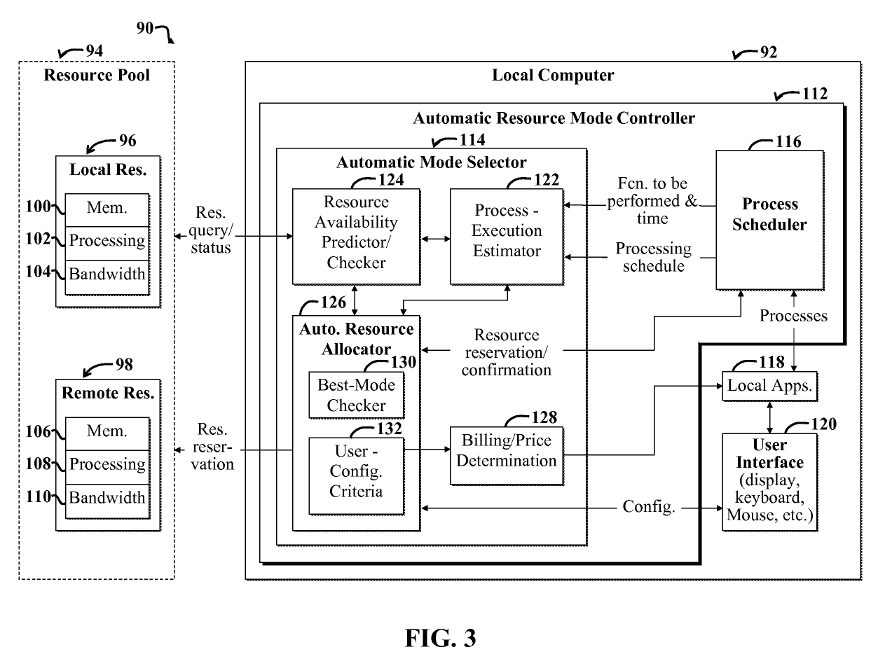

FIG. 3 shows a second example computing system 90 for enabling automatic allocation of local and/or remote resources to a given process. The computing system 10 includes a local computer 92, which has access to a pool of selectively allocable computing resources 94, which include local resources 96 and remote resources 98. The local resources 96 include local memory 100, processing 102, and bandwidth 104 resources. Similarly, the remote resources 98 include remote memory 106, processing 108, and bandwidth 110 resources. Note that other types of resources may be included or certain types of resources may be omitted from the selectively allocable resource pool 94 without departing from the scope of the present teachings.

The local computer 92 includes an automatic resource mode controller 112, which includes a process scheduler 116 in communication with an automatic mode selector 114. The automatic mode selector 114 communicates with local and remote resources 96, 98 of the resource pool 94. Note that while the resources 96, 98 are shown grouped in the same box, such resources may be at different locations.

The process scheduler 116 may control the scheduling and launching of various local applications 118. The local applications 118 communicate with a user interface 120, which may include a display, keyboard, mouse, and so on.

The automatic mode selector 114 includes a process-execution estimator 112 in communication with a resource availability predictor/checker 124 and an automatic resource allocator 126. The automatic resource allocator 126 includes a best-mode checker 130, which may facilitate allocating resources to a process based on a best mode as determined via user-configurable criteria 132 with reference to predictions as to resource availability as provided by the resource availability predictor/checker 124 and with reference to estimations provided by the process-execution estimator 122 as to what resources a given process will require at a particular future time. The user-configurable criteria 132 may be adjusted via input from the user interface 120.

The automatic resource allocator 126 also communicates with a billing/price determination module 128, which may estimate charges for reservation of a particular set of remote resources to accomplish a task. The charge/price information may be provided to one of the local applications 118 and displayed via the user interface 120. A user may then choose whether to proceed with the resource reservation at the given price. Such functionality may readily be implemented by those skilled in the art with access to the present teachings without undue experimentation. The billing/price determination module 128 may also include instructions for automatically billing a user account, such as a credit card account, for use of the remote resources.

In operation, a user employs the user interface 120 to selectively launch local applications 118. Such applications may include an application that enables a user to schedule tasks for completion via the process scheduler 116. For example, a user may wish to run a first application at 3:00 p.m. and activate a second process at 3:30 p.m. This timing or scheduling information may be forwarded to the process scheduler 116 via the user interface 120 and local applications 118. The process scheduler 116 then employs the scheduling information to arrange a process schedule, which may be forwarded to the process execution estimator 122. The process schedule may include information specifying that a particular function or group of functions, such as the first application or second process, is to be performed at a particular time.

The process execution estimator 122 may then run a simulation to estimate how long a given process will take at the scheduled time using of various combinations of local and remote resources. Estimates or predictions of the availability of the various resources 94 at the scheduled time, as provided by the resource availability predictor/checker 124 may be used to run the simulations and to estimate how long the process will take at the desired activation time. The simulations may include measuring or determining a total time delay required to transfer data to and from remote computing resources and factoring this time delay into the estimate as to how long the process will take to execute at the predetermined future execution start time.

The resource-availability predictor/checker 124 may use existing process scheduling information relayed from the process scheduler 116 to facilitate estimating the availability of various resources 94. The process execution estimator 122 may determine, for example, that at a predetermined future time, a given process will be most quickly implemented using remote processing resources 108 and local memory resources 100 or some other combination of local and/or remote resources. This may represent a proposed resource-allocation mode for the most efficient or expedient processing of a given computing task or process at the slated scheduled processing time.

The automatic resource allocator 126 may employ estimates of resource availability from the resource availability predictor/checker 124 in combination with estimates as to how long a given process will take to implement, as provided by the process execution estimator 122, to select a best resource-allocation mode. The best resource-allocation mode is selected by the best-mode checker 130 with reference to the predetermined criteria 132. For example, the criteria 132 may specify that the mode resulting in the quickest processing of a scheduled task be the selected mode. As another example, the criteria 132 may specify that process involving files beyond a given size be stored locally or that processes requiring less than a predetermined number of floating point operations be processed locally provided that the process can be completed within a predetermined time interval when launched at a desired future time. Whether a process can be completed with a certain time interval may be determined with reference to determinations made by the process-execution estimator 122.

After the resource allocator 126 determines the best operational mode for a process, i.e., the best combination of local and/or remote resources to complete the desired process or processes at the desired time in accordance with the criteria 132, the resource allocator 126 then allocates or reserves the appropriate resources 94 for the task. The resource reservation may be implemented in part by adjusting the process schedule of the process scheduler 11 6 to ensure that no other processes are scheduled to use the reserved resources at the scheduled time. In addition, or alternatively, the resource reservation is made by sending appropriate reservation signals to the resources 96, 98 of the resource pool 94 to reserve the resources. Note that the various resources 94 may include reservation functionality associated therewith, wherein the reservation functionality is responsive to a reservation signal from the automatic resource allocator 126. The reservation functionality may act to enable reservation of the resources for the given process at a desired time. Resource reservation information and general resource availability information may be provided by the resources 94 to the resource-availability checker 124.

Note that resource reservation functionality need not be implemented at the resources 94. Instead, such reservation may be achieved by controlling scheduling via the process scheduler 116 or other process scheduling mechanism.

Note that groupings of functionality corresponding to various modules illustrated in FIG. 3 are illustrative. Various modules may be combined, or certain modules may be omitted without departing from the scope of the present teachings.

An example method that may be implemented via the computing system 90 includes receiving, via the automatic mode selector 114, an indication of a function to be performed at a future time. The function may be a process or a collection or processes, such as an application. The method further includes determining a local resource limitation, such as via the resource availability predictor/checker 124, of performing the function at the future time. Subsequently, one or more remote computing resources are automatically allocated for the performance of the function.

The example method may further include first determining, such as via the process-execution estimator 122 and resource-availability predictor/checker 124, that performing the function with local computing resources will result in a first time delay to achieve a desired result; then determining, such as via the process-execution estimator 122, that achieving at least a portion of the result by using a selected portion of the remote computing resources will result in a second time delay; then determining, such via the best-mode checker 130, that a total time delay of transferring data to the remote computing resources and using the selected portion of the remote computing resources to achieve at least a portion of the result will be less than the first time delay; and then causing, such as via the automatic resource allocator 126, at least a portion of the function to be performed using the selected portion of the remote computing resources if the portion of the result will be less than the first time delay.

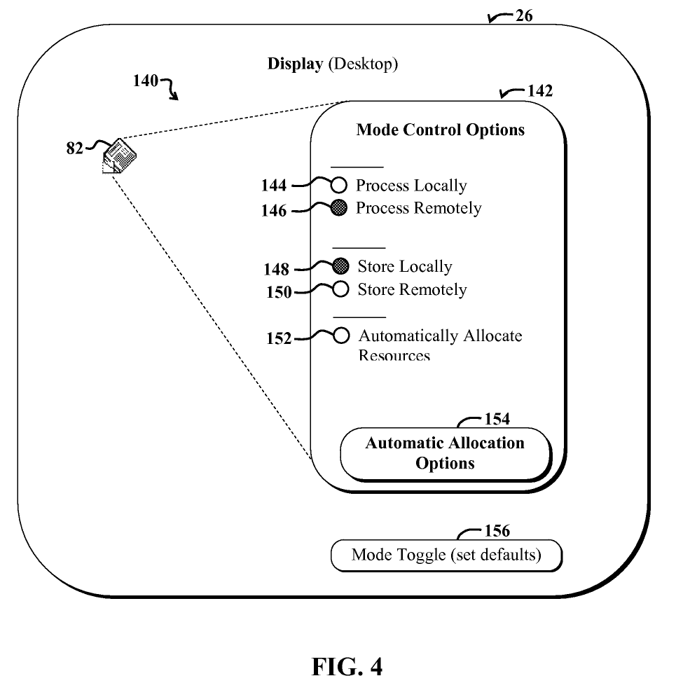

FIG. 4 shows a second example GUI 140, which provides user options to manually select between local or remote resources or to have local or remote resources automatically selected for the performance of a given computing task.

The GUI 140 includes a mode-control options dialog box 142, which may be activated via an icon 82, such as by using a mouse to right-click the icon 82. The icon 82 is associated with an application, function, process, or computing task or tasks to be performed using local and/or remote resources.

The example mode-control options dialog box 142 includes a local-processing radio button 144, a remote-processing radio button 146, a local-storage radio button 148, a remote-storage radio button 150, an automatic resource-allocation button 152, and an automatic resource-allocation options button 154.

In operation, a user right-clicks the icon 82 to display the mode-control options dialog box 142 and subsequently selects various options provided thereby. In the present illustrative operating scenario, the user has selected the remote-processing radio button 146, the local-storage radio button 148. Consequently, the process or application associated with icon 82 will be executed using one or more remote processors and one or more local memories. If the user had selected the automatic resource-allocation options button 154, the other radio buttons 144-150 would be deselected, and local and/or remote resources would automatically be allocated to the process, such as via the automatic resource mode controller 112 of FIG. 3.

Additional options, such as for specifying when the application or process associated with the icon 82 should be executed; for specifying criteria for how resources should be automatically selected, and so on, may be accessed by selecting the automatic resource-allocation button 154. Selection of the automatic resource-allocation button 154 may cause additional menus (not shown) to appear, whereby a user may establish certain resource-allocation profiles, which may containing automatic resource-allocation criteria. For example, an automatic resource-allocation profile may specify that if execution of a given process can be completed within a predetermined time interval using local resources, then local resources will automatically be allocated for the process. As another example, if use of remote resources or a combination or remote resources and local resources will result in a predetermined timesavings, then the remote resources or combination of remote and local resources will automatically be selected for execution of the process. As another example, if use of remote resources will minimize the time required to execute a process, but use of the remote resources will exceed a given price, then local resources may automatically be used. Such criteria may be established in different profiles that may be selected by a user via the automatic resource-allocation options button 154. Note that various criteria for determining automatic selection of resources for a given process are application specific. Those skilled in the art with access to the present teachings may readily determine which criteria-selection or criteria-specification options to provide to a user to meet the needs of a given application.

A mode-toggle button 156 is shown for illustrative purposes. A user may select the mode-toggle button 156 to toggle default resource allocation options or modes for processes launched via the GUI 140. For example, one mode may default processes to using local resources, while another mode may default processes to using remote resources, while yet another mode may default processes to automatically use the combination of local and/or remote resources that results in the shortest process execution time. Hence, the mode-toggle button 156 may enable a user to toggle between various modes. Furthermore, a user may set the various default modes by configuring certain profiles. Such profiles may be accessed, for example, by menus activated by right-clicking the mode-toggle button 156.

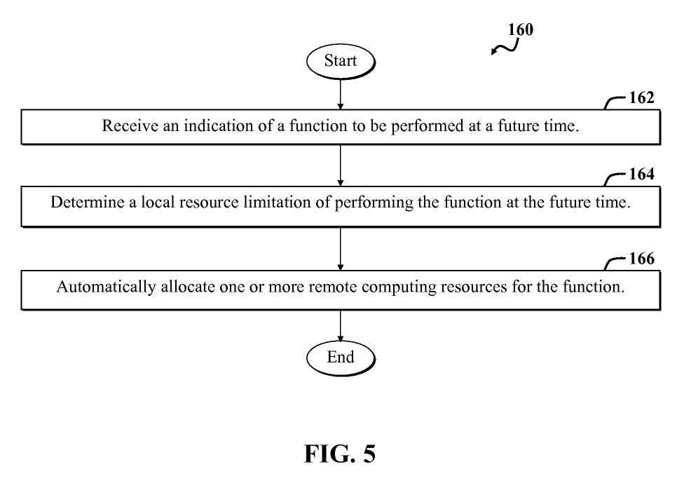

FIG. 5 is a flow diagram of a method 160 adapted for use with the computing systems 10, 90 of FIG. 1 and 3 and the GUI of FIG. 2. The method 160 includes a first step 162, which involves receiving an indication of a function to be performed at a future time. For the purposes of the present discussion, a function may be any computing process, task, or group of processes or tasks. A function may involve storing data and/or performing calculations with reference to or based on stored data and/or calculated data.

A second step 164 includes determining a resource limitation of performing the function at the future time. A resource limitation may be any characteristic or condition affecting a computing resource. For example, if a resource is not available or is otherwise only partially available at a given time, this condition is considered a resource limitation at the given time.

A third step 166 includes automatically allocating one or more remote computing resources for the function.

Although specific embodiments of the invention have been described, variations of such embodiments are possible and are within the scope of the invention.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method for allocating computing resources, wherein local computing resources includes local processing power and local storage, wherein remote computing resources include remote processing power and remote storage;
the method comprising:
receiving an indication of a function to be performed at a future time;
determining a local resource limitation of performing the function at the future time; and
automatically allocating one or more of the remote computing resources for performance of the function.

2. The method of claim 1, wherein a remote computing resource includes network bandwidth, the determining further comprising:
first determining that performing the function with local computing resources will result in a first time delay to achieve a desired result;
second determining that achieving at least a portion of the result by using a selected portion of the remote computing resources will result in a second time delay;
third determining that a total time delay of transferring data to the remote computing resources and using the selected portion of the remote computing resources to achieve at least a portion of the result will be less than the first time delay; and
causing, in response to the third determining, at least a portion of the function to be performed using the selected portion of the remote computing resources.

3. The method of claim 1, wherein automatically allocating includes automatically allocating a combination of resources selected from remote computing resources and local computing resources for the performance of the function.

4. The method of claim 3 wherein automatically allocating further includes automatically allocating the combination of resources based on one or more predetermined criteria.

5. The method of claim 4 wherein the one or more predetermined criteria include a minimum time required to execute the function.

6. The method of claim 4 wherein the one or more predetermined criteria are user configurable.

7. The method of claim 1 wherein determining a local resource limitation includes determining that use of a local resource will take longer than use of a corresponding remote resources.

8. The method of claim 7 further including determining a remote resource limitation for performing the function.

9. The method of claim 8 wherein automatically allocating further includes determining whether to use one or more local resources, one or more remote resources, or a combination of one or more local resources or one or more remote resources based on the local resource limitation and the remote resource limitation.

10. The method of claim 1 further including providing a price estimate for use of remote resources to execute the function.

11. The method of claim 10 further including automatic billing to a user of a local computer for remote resources used thereby.

12. A method for automatically selecting resources to be used by a given computing process, the method comprising:
determining resources that will be required for execution of the process;
ascertaining resource availability at and capabilities at a desired processing time; and
selecting an appropriate combination of resources from local and remote resources that will satisfy one or more predetermined criteria.

13. The method of claim 12 wherein the one or more predetermined criteria include a minimum time required to execute the process.

14. The method of claim 12 wherein ascertaining includes running one or more tests of local or remote resources.

15. The method of claim 12 wherein selecting an appropriate combination of resources includes selecting resources based on one or more user-specified criteria.

16. The method of claim 12 wherein selecting an appropriate combination or resources includes selecting the combination of resources that is estimated to result in execution of the process in a minimum amount of time.

17. An apparatus for allocating computing resources, wherein local computing resources includes local processing power and local storage, wherein remote computing resources include remote processing power, remote storage, and network bandwidth, the apparatus comprising:
a processor;
a computer-readable storage device including instructions executable by the processor for:
receiving an indication of a function to be performed at a future time;
determining a local resource limitation of performing the function at the future time; and
automatically allocating one or more of the remote computing resources for performance of the function.

18. The apparatus of claim 17, wherein a remote computing resource includes network bandwidth, the computer-readable storage device further comprising instructions executable by the processor for:
first determining that performing the function with local computing resources will result in a first time delay to achieve a desired result;
second determining that achieving at least a portion of the result by using a selected portion of the remote computing resources will result in a second time delay;
third determining that a total time delay of transferring data to the remote computing resources and using the selected portion of the remote computing resources to achieve at least a portion of the result will be less than the first time delay; and
causing, in response to the third determining, at least a portion of the function to be performed using the selected portion of the remote computing resources.

19. A computer-readable storage device for allocating computing resources, wherein local computing resources include local processing power and local storage, wherein remote computing resources include remote processing power, remote storage, and network bandwidth, the computer-readable storage device comprising one or more instructions for:
receiving an indication of a function to be performed at a future time;
determining a local resource limitation of performing the function at the future time; and
automatically allocating one or more of the remote computing resources for performance of the function.

20. The computer-readable storage device of claim 19, wherein a remote computing resource includes network bandwidth, the computer-readable storage device further comprising one or more instructions for:
first determining that performing the function with local computing resources will result in a first time delay to achieve a desired result;
second determining that achieving at least a portion of the result by using a selected portion of the remote computing resources will result in a second time delay;
third determining that a total time delay of transferring data to the remote computing resources and using the selected portion of the remote computing resources to achieve at least a portion of the result will be less than the first time delay; and
causing, in response to the third determining, at least a portion of the function to be performed using the selected portion of the remote computing resources.
